(19) United States
(12) Patent Application Publication
(10) Pub. No.: US 2017/0098046 A1
(43) Pub. Date: Apr. 6, 2017

(54) HIPAA COMPLIANT COMMUNICATIONS SYSTEM

(71) Applicants: Ryan Coughlan, Tulsa, OK (US); F. Maury Matthews, Brentwood, MO (US)

(72) Inventors: Ryan Coughlan, Tulsa, OK (US); F. Maury Matthews, Brentwood, MO (US)

(21) Appl. No.: 15/281,496

(22) Filed: Sep. 30, 2016

Related U.S. Application Data
(60) Provisional application No. 62/236,232, filed on Oct. 2, 2015.

(51) Int. Cl. G06F 19/00; H04L 29/06; G06F 21/62

(52) U.S. Cl. CPC G06F 19/328; G06F 21/6245; H04L 63/0428; H04L 63/06

(57) ABSTRACT

A HIPAA compliant communications systems (10) that enables the transfer of patient information from a repository (20) of such information to a device (30, 30′, 30″) at a location (40) where the information is needed. An initial dialogue between the repository and end user is established using a public key; but after that, each authorized transmission (AT) is accomplished using a private key (PK) which is changed for each communication.

### CROSS REFERENCE TO RELATED APPLICATIONS

This application is based upon and claims the benefit of U.S. provisional patent application 62/236,232 filed Oct. 2, 2015.

### STATEMENT REGARDING FEDERALLY SPONSORED RESEARCH OR DEVELOPMENT

N/A

### BACKGROUND OF THE INVENTION

The Health Insurance Portability and Accountability Act (“HIPAA”) includes privacy provisions that prevent protected patient information from being communicated from one party, person, or entity, to another party, person, or entity unless certain federally mandated guidelines are followed. While it is generally recognized that protection of patient confidentiality is important in many instances, in others circumstances, the restrictions imposed by Act on relaying a patient's information can be a significant hindrance. This can be particularly so in medical emergency or related situations where the need to access vital patient information and transmit it to medical personnel ministering to the person can mean the difference between life and death.

Communication systems such as cell phones, !pads, personal computers (PCs), tablets, etc. are well-known in the art and are commonly used in hospitals, emergency vehicles (such as ambulances, police cars, and fire department vehicles), doctor's offices, medical labs, etc. However, these current systems and devices are not completely HIPAA compliant which greatly limits their use in conveying necessary medial information from where it is stored to where it is needed. Of further concern is the possibility of unauthorized persons intercepting patient information during its transmission.

### BRIEF SUMMARY OF THE INVENTION

The present invention is directed to a HIPAA compliant medical communications system and device which greatly facilitates transferring protected patient information, in a secure format, from a site where the information is stored or kept to a using site where the person is located and the information is needed. The system includes a device or a series of devices that facilitate secure communications between two or more parties and envisions intermediate transfers of the protected information between a repository of the information and where it is ultimately needed. Regardless of the number of steps involved until the end user is provided the information, each step in the process is compliant with HIPAA regulations for the communication of patient information.

Importantly, the information is encoded in a secure format and remains encoded throughout the transmission process. If the transmission path includes intermediate stations, the information may be re-encoded at each step along the transmission path. The coding used is a random code making it difficult, if not impossible, to decode the patient information even if it is intercepted during transit.

Other objects and features will be in part apparent and in part pointed out hereinafter.

### BRIEF DESCRIPTION OF THE SEVERAL VIEWS OF THE DRAWINGS

FIG. 1 is a simplified representation of a communications system for patient data transfer between a first set of HIPAA compliant communication devices;

FIG. 2 is a simplified representation of the communications system for patient data transfer between a second set of HIPAA compliant communication devices;

FIG. 3 is a simplified representation of a communication path involving multiple transmissions of patient information from a repository of the information to a site where it is needed; and,

FIG. 4 is a block diagram of a HIPPA compliant communications device; and,

FIG. 5 is a flow chart for a method of communicating patient information in a HIPPA compliant manner.

Corresponding reference characters represent corresponding parts throughout the several views of the drawings.

### DETAILED DESCRIPTION OF THE INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

In accordance with the invention, a communications system 10 is used in transmitting patient data information from a repository 20 of such information to a site 40 where the information is required for ministering to the patient. Importantly, the transmission, receipt, and any subsequent re-transmission and re-receipt of the information complies with all current HIPAA rules and regulations regarding the transmission and receipt of such information.

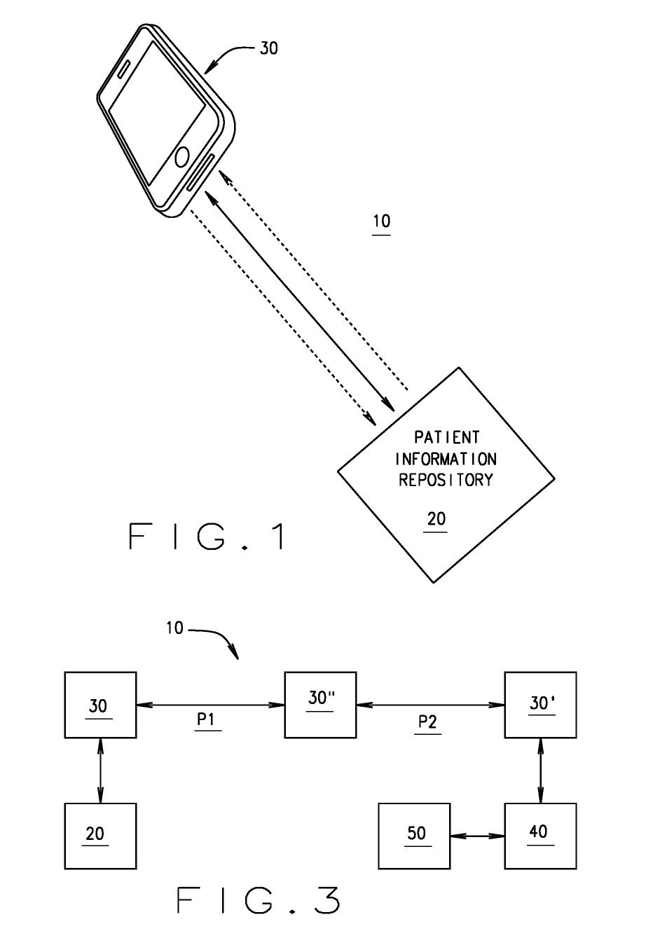

Referring to FIG. 1, a repository of patient information is indicated generally 20. Repository 20 is any facility in which medical and related information about patients is archived and kept. The patient information is updated, as required, so that the information stored in the repository is generally current as regards each patient whose information is kept at the facility. Patient information is stored in the facility and accessed therefrom in accordance with current HIPAA rules and regulations.

Also shown in FIG. 1 is a device 30 that facilitates secure communications between two authorized parties in an environment controlled by HIPAA regulations. Device 30 is shown in FIG. 1 as being a hand-held device such as a cell phone, but those skilled in the art will understand that other hand-held devices besides cell phones can be used. These include, but are not limited to Ipads, and tablets. Other devices which can be used include personal computers (PCs). It will be understood by those skilled in the art that communications between a repository and use site can be over the Internet, radio frequency (rf) transmissions, as well as conventional telephone systems (POTS).

In FIG. 1, one party is represented by repository 20 where the information is stored, and the other party is represented by device 30 which is located at site 40 where the patient information is required. This location is, for example, a doctor's office or clinic, a hospital's emergency room, patient room, operating room, or recovery room, an ambulance or other police or fire department vehicle, or an attendant at the scene of an emergency.

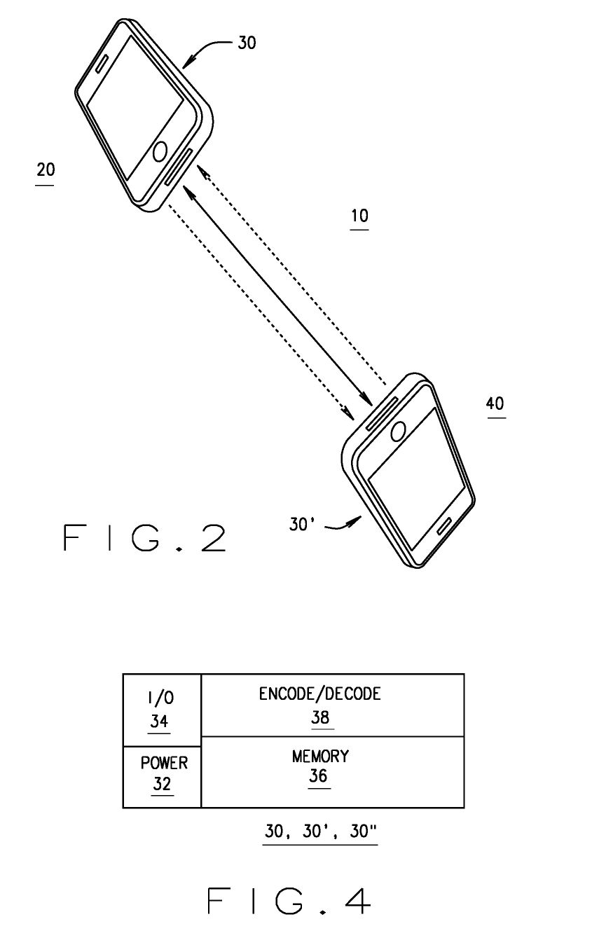

Next, it will be understood by those skilled in the art that, sometimes, information transferred from repository 20 to a compliant device 30, may be subsequently communicated from device 30 to another compliant device 30′ located at site 40. This is as shown in FIG. 2. Device 30′ is configured the same as device 30 insofar as transmitting patient information in a HIPPA compliant manner is concerned. Those skilled in the art will understand that system 10 and devices 30, 30′ are dedicated as to use and application only as a HIPAA authorized system and device.

If, for some reason, and as shown in FIG. 3, direct communication between repository and site 40 is not possible, the transmission path may include multiple segments between the repository and using site. In FIG. 3, a HIPPA compliant device 30 receives patient information from repository 20 and routs it over a segment P1 of the transmission to a HIPPA compliant device 30″. Device 30″, in turn, routs the information over a segment P2 of the path to HIPPA compliant device 30′. Device 30′, which is located at site 40, then provides the patient information to needed users. Those skilled in the art will appreciate that there may be more than two path segments between repository 20 and site 40 and since system 10 is designed to operate at ranges of up to 3,000 miles, multiple paths may be commonplace.

As also shown in FIG. 3, in some instances, a patient information repository 50 is located at site 40. Repository 50 is used, for example, for interim storage or archival of patient information as, for example, a procedure is performed on the patient. Subsequent to the procedure, the updated patient information in repository 50 is transmitted back from site 40 to repository 20.

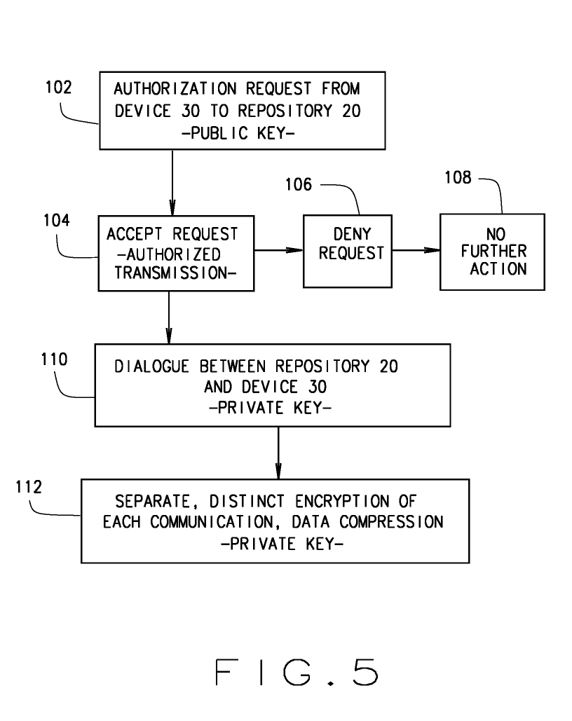

As shown in FIG. 4, each device 30, 30′, 30″ includes at least the following components: a source of power 32, an input/output module 34, a memory 36, and an encoder/decoder module 38 which also includes a message/data compression capability.

Information to and from the device is transmitted from, or received at, input/output module 34. The information is temporarily stored in memory in memory 36. If the information is being transmitted from the device, it is supplied to the encoder portion of module 38 for encryption prior to being transmitted through module 34. If the information is being received, it is directed from module 34 to the decoder portion of module 38 and then stored in memory 36. It will be noted that input/output module 34 is designed for use with a cableless printing system.

Referring to FIG. 5, in the operation of system 10, at step 102 an authorized party initiates a query regarding patient information. The query may come, for example, from a doctor contacting a hospital or clinic regarding a patient's care or status; a nurse or attendant contacting a doctor about a patient's care or status; or, a remote hospital or clinic contacting a doctor requesting patient information due to a health emergency involving the patient. When it is necessary to transmit patient information which is under the auspices of HIPAA, device 30 initiates a query or patient information request to repository 20. This is done using a public key such as is known in the art.

The response from repository 20, if the query meets established criteria for the transfer of information, is now considered an authorized transmission or AT. This is indicated at step 104. Further, it will be understood that each AT, besides being a direct transmission between the parties, can be an email, a text, a verbal transmission, or a combination thereof.

It will be understood that if, for any reason, the query or request does not meet the established criteria, no dialogue between repository 20 and device 30 is established, no further action is taken, and the patient information remains protected within the repository. This is indicated at steps 106 and 108.

If the authorization criteria are met, a dialogue is now established between the repository and the device using an authorized secure link (or private key PK) between the two users. This is step 110. Importantly, the PK establishes a secure dialogue between repository 20 and device 30 for each transmission between the two. That is, the PK first encrypts a transmission between repository 20 and device 30, and then separately encrypts the reply transmission between the repository and the device. At the end of each transmission, a new PK is implemented for the next communication between the two. Importantly for HIPAA purposes, no outside “listener” can access any of the dialogue between the repository and device encrypted using the PK. This is step 112.

The AT link is a continuous link and communications are encrypted using a derivative of a Standard Telephone Unit encryption program; e.g., STU III or STU V, or an equivalent encryption program incorporating a continuously changing random PK coding scheme, which may include scrambling, so to ensure a HIPAA compliant and secure transmission. What this means is that each succeeding communications between the repository 20 and device 30, and device 30 and device 30′, is separately encrypted using a coding scheme different from that of the preceding communication and any subsequent communication. Further, system 10 employs data compression techniques to improve transmission of patient information so that a transfer is performed as efficiently as possible.

The AT can be saved to a secure site (e.g., repository 50) as well on both the sender and receiver devices where it will be available to be accessed by certified and approved users using the AT for recording to patient records and or other legal records. Typically, patient information stored at repository 20 or 50 is stored in a plain language rather than encrypted.

In view of the above, it will be seen that the several objects and advantages of the present disclosure have been achieved and other advantageous results have been obtained.

What is claimed is:

1. A HIPPA compliant system for transmitting relevant patient information in a secure, encrypted format from a repository of such information to a location where the information is required comprising:
a first device capable for sending a request for patient information stored in a repository for such information that is HIPPA compliant, the request being made using a public key;
a second device capable of receiving and processing such requests to determine if the request is a valid request from one authorized to access patient information;
each device, once it is determined that the request is a valid request, switching from a public key to a private key, the private key being used for all subsequent transmissions, including the transmission of patient information, between the repository and said location; and
means within each device for encrypting all private key transmissions in a random code that is changed with each transmission for all communications involving patient information to be securely encrypted before transmission whereby no unauthorized individual or entity can access the patient information being transmitted.

2. The HIPPA compliant system of claim 1 wherein each device separately encrypts each message prior to its transmission.

3. The HIPPA compliant system of claim 2 wherein each device further includes compression means for compressing each message transmitted between the devices.

4. The HIPPA compliant system of claim 3 wherein a path over which patient information is transmitted has multiple segments and the system includes a separate device located at a juncture of each segment with each separate device encrypting each private key transmission the device receives and transmits in a random code that is changed with each transmission for patient information transmissions to be securely encrypted as the patient information is transmitted over each path segment.

5. The HIPPA compliant system of claim 4 wherein each device is a hand-held device.

6. The HIPPA compliant system of claim 5 wherein the hand-held device includes one of a cell phone, an Ipad, or a tablet.

7. The HIPPA compliant system of 4 wherein the device includes a personal computer.

8. The HIPPA compliant system 1 wherein the devices communicate over the Internet, by radio frequency, or a conventional telephone system.

9. The HIPPA compliant system of claim 1 wherein patient information transmissions are encrypted using a coding scheme that is a derivative of a Standard Telephone Unit encryption program, including STU III or STU V, or an equivalent encryption program, which incorporates a continuously changing random private key coding scheme.

10. The HIPPA compliant system of claim 9 wherein the coding scheme includes scrambling.

11. A method of transmitting patient information from a repository thereof to a location where the information is required for treatment of the patient, the transmission of patient information being in a HIPPA compliant manner, comprising:
transmitting an authorization request from a first HIPPA compliant device at a location where the patient information is needed to a second HIPPA compliant device at the repository of the information, the request being transmitted from the first device to the second device using a public key;
accepting the request and authorizing transmission of the patient information;
switching the first and second devices from a public key to a private key which is used for all subsequent transmissions between the first and second devices; and,
encrypting all private key transmissions between the first and second devices in a random code that is changed with each transmission between the first and second devices for all communications involving patient information to be securely encrypted before transmission whereby no unauthorized individual or entity can access the patient information being transmitted.

12. The method of claim 11 wherein each device separately encrypts each message prior to its transmission.

13. The method of claim 12 further including each of the first and second devices compressing each message transmitted between the devices.

14. The method of claim 11 wherein a path over which patient information is transmitted has multiple segments and the method includes a separate device located at a juncture of each segment of the path, and the method further includes each separate device encrypting each private key transmission the device receives and transmits in a random code that is changed with each transmission for patient information transmissions to be securely encrypted as the patient information is transmitted over each path segment.

15. The method of claim 11 wherein patient information transmissions are encrypted using a coding scheme that is a derivative of a Standard Telephone Unit encryption program, including STU III or STU V, or an equivalent encryption program, which incorporates a continuously changing random private key coding scheme.

16. The method of claim 15 wherein the coding scheme includes scrambling.
